(19) United States
(12) Patent Application Publication
(10) Pub. No.: US 2019/0213736 A1
(43) Pub. Date: Jul. 11, 2019

(54) APPARATUS FOR TUBULUS DETECTION FROM A TISSUE BIOPSY

(71) Applicant: KONINKLIJKE PHILIPS N.V., EINDHOVEN (NL)

(72) Inventors: CHRISTIAAN VAREKAMP, VELDHOVEN (NL); PIETER JAN VAN DER ZAAG, WAALRE (NL); MICHEL JOZEF AGNES ASSELMAN, HELMOND (NL)

(73) Assignee: KONINKLIJKE PHILIPS N.V., Eindhoven (NL)

(21) Appl. No.: 16/328,296

(22) PCT Filed: Aug. 28, 2017
(86) PCT No.: PCT/EP2017/071480

§ 371 Date: Feb. 26, 2019

(30) Foreign Application Priority Data
Aug. 31, 2016 (EP) 16186487.1

(51) Int. Cl. G06T 7/00

(52) U.S. Cl. CPC G06T 7/0012; G06T 2207/30081; G06T 2207/30024; G06T 2207/10056

(57) ABSTRACT

The present invention relates to an apparatus (10) for tubulus detection from a tissue biopsy. It is described to provide (210) a plurality of 2D images of a tissue biopsy, wherein each 2D image corresponds to a different depth position in the tissue biopsy, and wherein each 2D image comprises image data of the tissue biopsy. A measure of a local variation of intensity is determined (220) in the image data of the tissue biopsy in a region of at least one 2D image. At least part of a tubulus is located (230) in the region of the at least one 2D image on the basis of the determined measure of the local variation of intensity. The locating (230) involves determining (240) locations in the region of the at least one 2D image where the measure of the local variation in intensity is below a threshold. Data representative of the location of the at least part of the tubulus in the region of the at least one 2D image are output (250).

### FIELD OF THE INVENTION

The present invention relates to an apparatus for tubulus detection from a tissue biopsy, to a system for tubulus detection from a tissue biopsy, and to a method for tubulus detection from a tissue biopsy, as well as to a computer program element and a computer readable medium.

### BACKGROUND OF THE INVENTION

Analyzing tissue using 2D pathology requires that tissue samples are cut into thin slices, of the order of 4 μm thickness, and stained in order to increase image contrast. Recently, developments in 3D pathology have been made, enabling for example growth patterns of cancer to be better visualized and analyzed. However, the detection of tubular features in imagery is based on colour intensity through the use of stains being applied to tissue biopsies, and the use of exotic microscopy techniques such as confocal microscopy and Optical Projection Tomography.

For example:

K. Chung et al. Structural and molecular interrogation of intact biological systems, Nature 497 (2013) 332 (May 2013), describe a method for transforming intact tissue such that it becomes optically transparent and macromolecule-permeable. This is carried out by a method termed CLARITY. It is stated that CLARITY could potentially enable analysis of subcellular molecular architecture in large volumes with resolution at the diffraction limit of light microscopy, in an approach complementary to thin mechanical sectioning and three-dimensional reconstruction. This is demonstrated by examples of fluorescent confocal microscopy imaging on brain tissue of mice. Light sheet microscopy and tomography based microscopy can also be used in this respect.

R. Das, C. W. Burfeind, G. M. Kramer, and E. J. Siebel, “Pathology in a tube, stepl: fixing, staining and transporting pancreatic core biopsies in a microfluidic device for 3D imaging”, Proc. SPIE Vol. 8976, 89760R-1 (2014); R. Das, R. G. Murphy and E. J. Siebel, “Beyond isolated cells: microfluidic transport of large tissue for pancreatic cancer”, Proc. SPIE Int. Soc. Opt. Eng. 2015 (Mar. 5) 9320 describe an approach where core biopsy tissues can be transported using microfluid channels. It is described that this can be combined with 3D imaging platforms for imaging whole tissue in a transparent tube, for example using optical projection tomography microscopy. Stained tissue is used during the 3D imaging and in papers referred to by Das et al., imagery of the suspension of fixed and stained cells in optical gel and a reconstruction and 3D rendering of individual lung cells of a fine needle aspirate are shown.

In U.S. Pat. No. 8,003,388 B2 a method is described for creating an in-vitro network of microvessels. By injecting cells into a channel, and allowing them to attach, a network of vessels and microvessels will grow in the surrounding gel. The aim is to study and get an understanding of the mechanisms behind vascular growth of blood vessels. It is not prescribed what approach is to be used for observing or detecting the size and location of the grown vessels, however microscopy is mentioned as an example.

In J. Janacek et. al. 3D Microscopic Imaging and Evaluation of Tubular Tissue Architecture. Physiol. Res. 63 (Suppl. 1): S49-S55, 2014, a method is presented for detecting the capillary bed in a rat brain. The 3D image data is generated from confocal laser scanning microscopy of perfusion stained whole tissue, using fluorescent dyes. A second method is described using Optical Projection Tomography (OPT), where data need to be collected from multiple angles to make a 3D reconstruction.

H. Morales-Navarrete el. al. A versatile pipeline for the multi-scale digital reconstruction and quantitative analysis of 3D tissue architecture. Computational and systems biology Developmental biology and stem cells. eLife 2015; 4:e11214. DOI: 10.7554/eLife.11214, describe that serial sections of fixed tissues of mouse liver were prepared at a thickness of 100 μm, and were stained in order to distinguish sinusoids cells and bile canalicular cells from other tissue. Stained sections were imaged sequentially (generating Z-stacks) by one- and two-photon laser scanning confocal microscopy, using different excitation wavelengths for different structures. The image data of the sections was registered and combined into a single volumetric 3D image. After denoising, segmentation is done using Local Maximum Entropy, 3D segmented surfaces are generated using a marching cubes approach.

A. Fakhrzadeh. Computerized Cell and Tissue Analysis. Digital Comprehensive Summaries of Uppsala Dissertations from the Faculty of Science and Technology 1262 ISBN 978-91-554-9269-4, describes two automated methods for segmentation of tubules in transverse tissue slices of testicular tissue. Both approaches have in common a detection of stained epithelium cells that are surrounding the tubuli, and analysis is done on 2D image data of each individual slice. The background is removed by subtracting lower Lipschitz envelope, after thresholding the binary image of capillaries is thinned using a skeletonization algorithm. From this a spatial geometric graph is generated, which is used for further analysis. The tissue samples are cut in slices, stained and digital RGB images of the sections were taken with a Nikon Microphot-FXA microscope.

A. D. Belsare and M. M. Mushrif. Histopathological image analysis using image processing techniques: an overview. Signal & Image Processing: An International Journal (SIPIJ) Vol. 3, No. 4, August 2012, describes imaging processing techniques used for histopathology, for the purpose of cancer detection and classification. One of the approaches referred to relates to the identification of tubules. This approach is however based on histopathology, and the analysis of 2D microscopy images of stained, sliced tissue. Other approaches referred to use either 2D images of stained slices of tissue or 3D volumetric data generated by fluorescent confocal imaging.

S. H Ong et al. Adaptive window-based tracking for the detection of membrane structures in kidney electron micrographs. Machine Vision and Applications, Vol. 6 pages 215-223 (1993) describes an algorithm for the detection and measurement of the glomerular basement membrane in kidney electron micrographs by image analysis techniques. Starting from a user-specified point, local features within a small window are computed to give a feature score. Feature scores for adjacent neighbourhoods are also determined, and windows that satisfy similarity criteria are linked to produce the centreline of the membrane. A region growing process completes the segmentation procedure. It is described that the adaptive and local nature of the algorithm ensures successful segmentation despite the complex and variable characteristics micrograph image.

Thus, the state-of-the-art relates to the detection of features such as tubuli and ducts in a biopsy, based on the use of dyes and staining and on feature detection based on colour intensity. Tissue samples are generally required to be cut into thin slices. Sophisticated, exotic and expensive detection systems are required, such as those based on confocal microscopy and OPT technology.

### SUMMARY OF THE INVENTION

Therefore, it would be advantageous to have an improved technology for detecting tubuli, and ducts in tissue biopsies.

The object of the present invention is solved with the subject matter of the independent claims, wherein further embodiments are incorporated in the dependent claims. It should be noted that the following described aspects of the invention apply also for the apparatus for tubulus detection from a tissue biopsy, system for tubulus detection from a tissue biopsy and the method for tubulus detection from a tissue biopsy, and for the computer program element and the computer readable medium.

According to a first aspect, there is provided an apparatus for tubulus detection from a tissue biopsy, comprising:
an input unit;
a processing unit; and
an output unit.

The input unit is configured to provide the processing unit with a plurality of 2D images of a tissue biopsy. Each 2D image corresponds to a different depth position in the tissue biopsy, and each 2D image comprises image data of the tissue biopsy. The processing unit is configured to determine a measure of a local variation of intensity in the image data of the tissue biopsy in a region of at least one 2D image. The processing unit is configured to locate at least part of a tubulus in the region of the at least one 2D image on the basis of the determined measure of the local variation of intensity. This comprises a determination of locations in the region of the at least one 2D image where the measure of the local variation in intensity is below a threshold. The output unit is configured to output data representative of the location of the at least part of the tubulus in the region of the at least one 2D image. Thus, each 2D image can relate to image data originating from a single focal plane, for example as provided in the case of a Philips oCello scope system.

The apparatus can therefore detect one or more tubulus (tubuli), and can also detect ducts and other regions within tissue, where there is an absence of tissue.

The present apparatus is able to determine a measure of a local variation of intensity in the image data of an intact tissue biopsy, with the plurality of 2D images being of an intact tissue biopsy.

The term “intact tissue biopsy” relates to a tissue biopsy that has not been cut into thin slices as done in normal pathology imaging, where the tissue sample is cut into slices of the order of 4-10 μm thickness. In contrast, the present apparatus enables examination of a tissue biopsy that has not been cut into such thin slices, and in that respect is “intact”.

In this manner, visualisation of ducts (or tubuli) in an intact tissue biopsy is enabled, without the need to stain the tissue biopsy. By analysing imagery on the basis of a measure of local variation of intensity in the image data, rather than on an analysis of colour intensity, enables a thicker biopsy to be imaged as there is less absorption of light and redistribution of light caused by the emission of labelled cells due to staining. The tissue biopsy does not need to be sliced. Also, geometric information of the local widths and topology of the tubuli is preserved, and 3D information on the geometry of the tubuli is generated. In other words, in conventional 2D pathology, geometric information on the widths of tubuli and on the topology is not preserved, however by having a 3D representation the widths of the tubuli can be estimated, and information on the topology provided.

To put this another way an apparatus, system and method are provided that relate to 3-D pathology, in particular imaging the ducts and tubuli in a tissue biopsy, for example a prostate biopsy. However, unlike in conventional digital pathology where the biopsy must be sliced and stained, the biopsy remains intact and thus is thick, and the sample need not be stained in order to detect tubular features in the biopsy.

Segmentation of tubuli in the intact tissue biopsy is automatically enabled. That staining is not required in order to visualise the ducts (or tubuli) in the intact tissue biopsy then enables other stains to be applied for other specific purposes such as to image in more detail certain molecules or biomarkers and detect other tissue properties such as immune cells. A simple to use and inexpensive imaging system, such as a bright field microscope or a tomography microscope, can be used to acquire the image data rapidly. This contrasts with the need to use a confocal microscope, which is very expensive and image acquisition is slow. Additionally, intact tissues can be analyzed to determine their functions, and the visualisation of cancer tissue is provided. By being able to analyse a thicker sample, epithelial layers (forming in a tubulus) can be visualised and located, and allows for the improved analysis of whether a tumour is invasive (and penetrates surrounding tissue) or is ductal (growth stays confined within ducts). By not having to slice the tissue biopsy, more material can be analysed and less material is lost, and the tissue biopsy can still be used for traditional 2D histology workflow.

In an example, the determination of the measure of the local variation of intensity comprises a determination of at least one degree of focus in the image data of the tissue biopsy.

In other words, by using a measure of sharpness in an image and/or a measure of degree focus in an image, a tubulus can be detected in an area of imagery based on the “blur” in the area.

In this manner, the presence of out-of-focus areas in the imagery can be used to determine the location of tubuli, as opposed to areas in the imagery which are relatively more in focus and which indicate that tissue is at that location. This is because the areas are out-of-focus due to imaging of the cavities of tubuli, which contain gas and/or liquid but not (solid) tissue components. To put this another way, the sharpness and/or degree of focus in imagery can be used for tubulus detection, without the need for staining or cutting of the sample into thin slices.

In an example, the determination of the measure of the local variation of intensity comprises a determination of at least one spatial frequency in the image data of the tissue biopsy.

In this manner, spatial frequencies in the image data can be used to differentiate between tubuli and surrounding tissue. This is because the presence of relative high spatial frequencies at an image location is indicative of the presence of tissue, with lower spatial frequencies being indicative of the presence of tubuli. This is because inside a tubulus there is generally only gas and/or liquid and tissue cells are largely absent, leading to a determination of lower spatial frequencies at the location of a tubulus. Tissue exhibits higher spatial frequencies in the image data due to scattering or absorption at cell nucleus/membrane boundaries. To put this another way, spatial frequencies can be used for tubulus detection, without the need for staining or cutting of the sample into thin slices.

In an example, locating the at least part of the tubulus comprises an analysis of a variation of the at least one spatial frequency.

In other words, a variation in spatial frequencies in image data is used to detect a tubulus. Spatial frequencies associated with solid tissue are relatively high in comparison to spatial frequencies associated with a tubulus, because solid tissue is characterised by higher spatial frequencies due to scattering or absorption at cell nucleus/membrane boundaries, whilst tubuli are cavities containing gas and/or liquid with solid cells being largely absent, and are therefore characterised by relatively lower spatial frequencies. Thus, at the solid tissue/tubulus boundary there will be a relatively discontinuous (or abrupt) change in spatial frequency, and this can be used to determine the location of the tubulus. To put this another way, the outer boundary of the tubulus can be identified and located.

In an example, the analysis comprises utilisation of a high-pass filter.

This provides for a computationally efficient way for detecting tubuli from surrounding tissue.

In an example, the determination of the at least one spatial frequency in the image data of the tissue biopsy comprises application of at least one 2D filter on each 2D image of the at least one 2D image. In an example, local averaging of the magnitude of high spatial frequencies is applied, providing robustness for local variations in high-frequency magnitudes.

In an example, the threshold is an adaptive threshold determined on the basis of at least one magnitude of the at least one spatial frequency.

In this manner, robustness is provided with respect to variations within image data caused by variations in thickness and/or variations in transparency and/or variations in absorption/scattering. In this way, tissue samples can be interrogated with minimal processing and the tissue sample can be thick without having to have had some biomolecules “cleared”. Samples need not be cut or stained, and simple microscope systems such as for example Bright Field Microscope systems can be utilised.

In an example, the at least one 2D image comprises at least two 2D images, and wherein the determination of the at least one spatial frequency in the image data of the tissue biopsy comprises application of a 3D filter on the at least one 2D image.

In this manner, more efficient location and identification of a tubulus outer surface that goes from one slice to the next in the volume is provided due to the continuity of such a surface passing from one 2D image to this next. Thus rather than finding an outer surface in each 2D image and piecing these sections of outer surface together to generate a complete tubulus outer surface, by processing a complete 3D image the tubulus outer surface is better identified and located as a whole because it passes continuously, or at least generally continuously, from one 2D image to the next and this continuity can be utilized in better identifying and locating the tubulus.

In an example, locating the at least part of the tubulus comprises a determination of at least a part of an outer surface of the tissue biopsy in the image data of the tissue biopsy.

In this manner, segmentation of tubuli is better enabled. This is because some tubuli touch the outer surface of the biopsy, and segmentation a tubulus separately from the outer surface of the biopsy can be difficult. Therefore, by locating the outer surface of the biopsy, the outer surface of the biopsy can be excluded from the indication of the segmentation of the tubulus, thereby providing for better visualisation of the tubuli, without the need for staining or cutting of the biopsy into thin slices.

In an example, the tissue biopsy has a thickness d in the range 50 μm≤d≤5 mm.

In other words, the tissue biopsy has not had to be cut into thin slices as required for normal 2D pathological imaging.

In an example, the tissue biopsy has not been stained.

In this manner, simplicity of processing is provided. In not requiring staining of the tissue in order to locate tubuli, ducts and other cavities also means that the tissue sample can then be stained for other purposes, such as for the identification and locating of specific biomolecules. Also, the tissue sample can be further processed using the regular 2D histology workflow.

According to a second aspect, there is provided a system for tubulus detection from a tissue biopsy, comprising:
an image acquisition unit; and
an apparatus for tubulus detection from a tissue biopsy according to the first aspect.

The image acquisition unit is configured to acquire the plurality of 2D images of the tissue biopsy.

In a third aspect, there is provided a method for tubulus detection from a tissue biopsy, comprising:

a) providing a plurality of 2D images of a tissue biopsy, wherein each 2D image corresponds to a different depth position in the tissue biopsy, and wherein each 2D image comprises image data of the tissue biopsy;
b) determining a measure of a local variation of intensity in the image data of the tissue biopsy in a region of at least one 2D image;
c) locating at least part of a tubulus in the region of the at least one 2D image on the basis of the determined measure of the local variation of intensity, comprising:

c1) determining locations in the region of the at least one 2D image where the measure of the local variation in intensity is below a threshold; and

d) outputting data representative of the location of the at least part of the tubulus in the region of the at least one 2D image.

According to another aspect, there is provided a computer program element controlling apparatus as previously described which, in the computer program element is executed by processing unit, is adapted to perform the method steps as previously described.

According to another example, there is provided a computer readable medium having stored computer element as previously described.

Advantageously, the benefits provided by any of the above aspects and examples equally apply to all of the other aspects and examples and vice versa.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic representation of an example of an apparatus for tubulus detection from a tissue biopsy;

FIG. 2 shows a schematic representation of an example of a system for tubulus detection from a tissue biopsy;

FIG. 3 shows an example of a method for tubulus detection from a tissue biopsy;

FIG. 4 shows in the top series of images, raw images at different depths within a tissue biopsy, and in the bottom series of images, those raw images have been processed to identify the locations of tubuli;

FIG. 5 shows a series of processed images at different depths within a tissue biopsy;

FIG. 6 shows a schematic illustration of an example of morphological operations that are applied to processed image data;

FIG. 7 shows 3D surface renderings of cavities within a tissue biopsy; and

FIG. 8 shows 3D surface renderings of cavities within a tissue biopsy as shown in the left hand image of FIG. 7, along with an outer surface of a 3D biopsy within which the cavities are located.

### DETAILED DESCRIPTION OF EMBODIMENTS

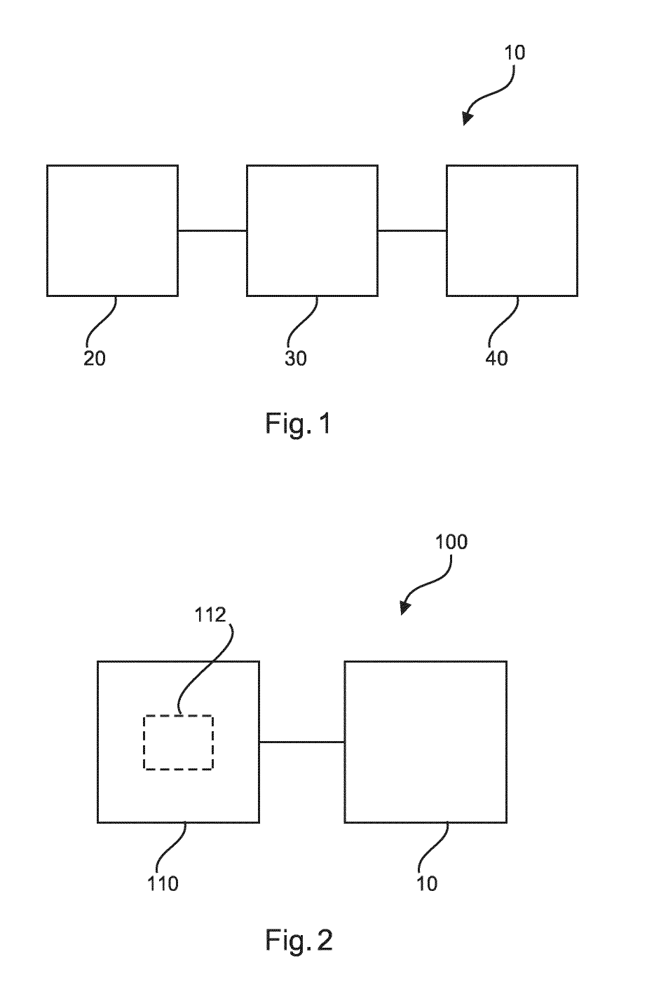

FIG. 1 shows an apparatus 10 for tubulus detection from a tissue biopsy. The apparatus 10 comprises an input unit 20, a processing unit 30, and an output unit 40. The input unit 20 is configured to provide the processing unit 30 with a plurality of 2D images of an intact tissue biopsy. Each 2D image corresponds to a different depth position in the intact tissue biopsy, and each 2D image comprises image data of the intact tissue biopsy. The processing unit 30 is configured to determine a measure of a local variation of intensity in the image data of the intact tissue biopsy in a region of at least one 2D image. The processing unit 30 is also configured to locate at least part of a tubulus in the region of the at least one 2D image on the basis of the determined measure of the local variation of intensity. This locating comprises a determination of locations in the region of the at least one 2D image where the measure of the local variation in intensity is below a threshold. The output unit 40 is configured to output data representative of the location of the at least part of the tubulus in the region of the at least one 2D image.

In an example, certain biomolecules are removed from the intact tissue biopsy while retaining other biomolecules in the intact tissue biopsy. In an example, a Clarity protocol has been applied to the intact tissue biopsy in order to remove certain biomolecules from the intact tissue biopsy while retaining other biomolecules in the intact tissue biopsy. In an example, the Clarity protocol has been used to remove lipids from the intact tissue biopsy. An example of the Clarity protocol can be found in the following paper: K. Chung et al. Structural and molecular interrogation of intact biological systems, Nature 497 (2013) 332 (may 2013).

In an example, image data of the intact tissue biopsy is spectrally non-discriminated. In other words, no spectral discrimination is required through the use of fluorescent dyes and/or optical filters such as pass-band filters or the use of radiation sources having specific spectral radiation characteristics, such as laser radiation or radiation that has been spectrally modified through the use of a pass-band filter for example. In an example, the image data can be obtained utilising a white light source or light. In an example, the image data are detected with a detector that is detecting broad-band radiation, such as detecting white light over a broad band of wavelengths.

In an example, the at least one 2D image comprises at least two 2D images.

In an example, the plurality of 2D image has been acquired by a transmission microscopy technique.

In an example, the plurality of 2D image has been acquired by a Bright Field Microscope.

In an example, the threshold is a predetermined threshold.

According to an example, the determination of the measure of the local variation of intensity comprises a determination of at least one degree of focus in the image data of the intact tissue biopsy.

In an example, the at least one degree of focus relates to a size of features being imaged. In other words, in a region where feature sizes are relatively small tissue can be considered to be in focus, however when a tubulus (which contains gas and/or liquid) is at the point of focus, there will be few features in focus. Tissue that lies above and below the focal plane, outside of the tubulus, will then be out of focus and those features will be washed out and generally feature sizes will appear to be larger, and features will appear to have a courser scale. In an example, the at least one degree of focus relates to an intensity of features being imaged. In other words, in a region where feature sizes are relatively small and in focus such as where there is tissue the changes in intensity across local features of the image data will be relatively high, however when a tubulus (which contains gas and/or liquid) is at the point of focus, there will be few features in focus. Tissue that lies above and below the focal plane, outside of the tubulus, will then be out of focus and those features will be washed out and generally the changes in intensity at a local scale of the image data at the position of the tubulus will be lower. In other words, the contrast changes as a result of focus distance, and the scale of finest observable detail reduces. To put this another way, as features go out of focus the contrast becomes lower, with the change in intensity from peaks to troughs in intensity reducing. In other words, due to absorption and scattering of light by e.g. nuclei that are in focus, the intensity drops locally. As a result neighbouring images that are out of focus can have locally higher intensity values.

In an example, the at least one degree of focus can relate to at least one step, a distance between 2 images, from an image that was found to be in focus.

In an example, the determination of the measure of the local variation of intensity comprises a determination of at least one measure of sharpness in the image data of the intact tissue biopsy. In an example, the at least one measure of sharpness relates to one or more of: a transient change in image data; a textural change in image data; a gradient in the intensity of image data; a curvature in the image data.

According to an example, the determination of the measure of the local variation of intensity comprises a determination of at least one spatial frequency in the image data of the intact tissue biopsy.

In an example, a fast Fourier transform is used to determine spatial frequencies. In an example, a Finite Impulse Response (FIR) or Infinite Impulse Response (IIR) high pass filter is used to determine spatial frequencies. In an example, an output value from the FIR or IIR filter is compared to the threshold in order to determine locations in the image data corresponding to tubuli, ducts, or other absences of tissue. In an example, an absolute output value of the FIR or IIR filter is used in this respect. In an example, rather than an absolute value, another polynomial—or non-linear function—could be applied (e.g. taking the square). In other words, a measure of local magnitude of spatial frequency is determined and compared with a threshold level, and this is used to determine where there is tissue and where there is an absence of tissue, and hence a tubulus, duct or other void or absence of tissue. The output of the FFT can be used in the same way.

In an example, an absolute value of the output is taken to express the magnitude of the spatial frequencies in a local area, and this value is compared to a threshold level.

According to an example, locating the at least part of the tubulus comprises an analysis of a variation of the at least one spatial frequency.

According to an example, the analysis comprises utilisation of a high-pass filter.

According to an example, the determination of the at least one spatial frequency in the image data of the intact tissue biopsy comprises application of at least one 2D filter on each 2D image of the at least one 2D image.

In an example, application of the at least one 2D filter comprises application of a FIR high pass filter. In this manner, 2D data is provided comprising a metric expressing the magnitude of high spatial frequencies present. Here “magnitude” can relate to the amount of high spatial frequencies present. In an example, the magnitude information is obtained after application of the operation that determined the absolute value.

In an example, application of the at least one 2D filter comprises application of a FIR low pass filter. In this way, local spatial variations in the magnitude of high frequencies can be smeared out. In an example, the low pass filter is applied on the output of the absolute value operation, therefore on the 2D image containing the magnitude information.

According to an example, the threshold is an adaptive threshold determined on the basis of at least one magnitude of the at least one spatial frequency.

In an example, the adaptive threshold is determined on the basis of at least one magnitude of frequency in a lower frequency band and/or higher frequency band of the at least one spatial frequency. In an example, a 2D FIR filter (or IIR filter or FFT filter) is used to determine the magnitude of frequency in the lower frequency band.

In an example, the adaptive threshold is determined on the basis of a ratio between 1) a magnitude of frequency in a higher spatial frequency band of the at least one spatial frequency and 2) a magnitude of frequency in a lower spatial frequency band of the at least one spatial frequency. This ratio (1:2) can then be compared to a predetermined threshold to determine if image data of the intact tissue biopsy relates to solid tissue or relates to a tumulus, duct or other void. In an example, a 2D FIR filter (or IIR filter or FFT filter) is used to determine the magnitude of frequency in the lower frequency band. In an example, a 2D FIR filter (or IIR filter or FFT filter) is used to determine the magnitude of frequency in the higher frequency band. In this manner, by using a ratio between a high spatial frequency and a low spatial frequency, robustness is provided to local variations of light intensity (for example due to thicker tissue, variation in scattering or absorption through the tissue).

In an example, application of the at least one 2D filter comprises application of a FIR high pass filter. In this manner, 2D data is provided comprising a metric expressing a high frequency magnitude of frequency.

According to an example, the at least one 2D image comprises at least two 2D images, and wherein the determination of the at least one spatial frequency in the image data of the intact tissue biopsy comprises application of a 3D filter on the at least one 2D image.

In an example, the 3D filter is configured to eliminate small volume cavities from the image data and thereby helps facilitate determination of the global tubulus, or duct. In other words, by getting rid of smaller cavities the larger cavities can be better visualised. In an example, the 3D filtering comprises low pass filtering using a Gaussian kernel. In an example, the 3D filtering comprises low pass filtering in each of the x, y, z directions using a Gaussian kernel. This can lead to a smoothing of the surfaces of the tubuli. However, the parametric space of the 3D filter can be adjusted to optimise the elimination of the small volumes with respect to smoothing of tubuli surface smoothing in order to optimise utilisation of the 3D filter.

According to an example, locating the at least part of the tubulus comprises a determination of at least a part of an outer surface of the intact tissue biopsy in the image data of the intact tissue biopsy.

According to an example, the intact tissue biopsy has a thickness d in the range 50 μm≤d≤5 mm.

In an example, the intact tissue biopsy has a thickness d in the range 100 μm≤d≤5 mm.

According to an example, the intact tissue biopsy has not been stained.

FIG. 2 shows a system 100 for tubulus detection from a tissue biopsy. The system 100 comprises an image acquisition unit 110 and an apparatus 10 for tubulus detection from an intact tissue biopsy as described with respect FIG. 1. In the system 100, the image acquisition unit 110 is configured to acquire the plurality of 2D images of the intact tissue biopsy.

In an example, the image acquisition unit is a Bright Field Microscope 112.

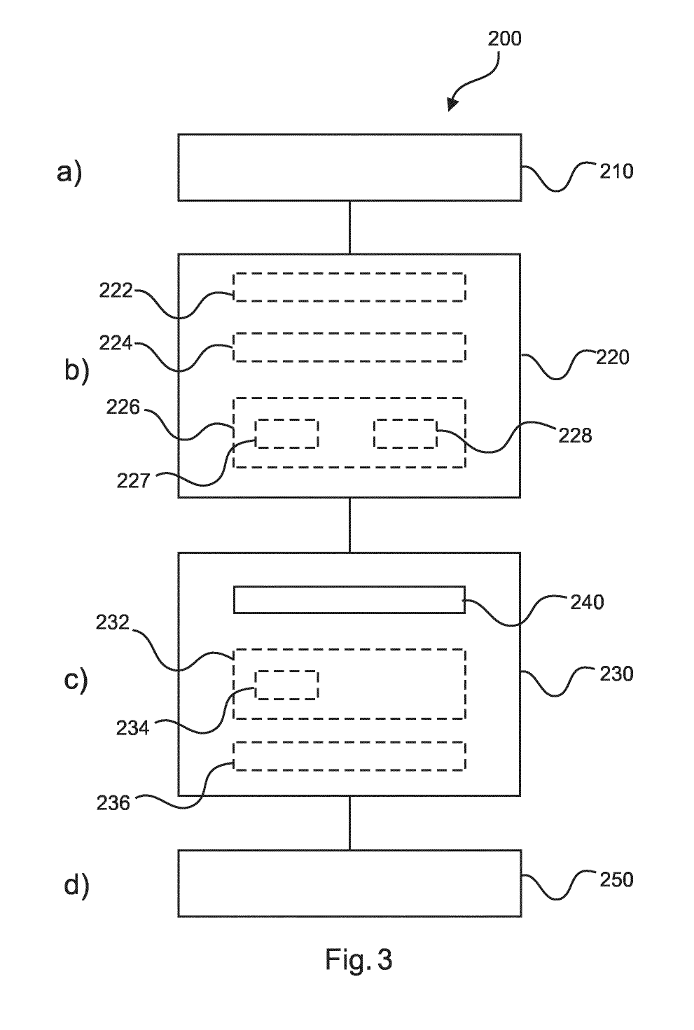

FIG. 3 shows a method 200 for tubulus detection from a tissue biopsy in its basis steps. The method 200 comprises:

in a providing step 210, also referred to as step a), a plurality of 2D images of an intact tissue biopsy is provided, wherein each 2D image corresponds to a different depth position in the intact tissue biopsy, and wherein each 2D image comprises image data of the intact tissue biopsy;

in a determining step 220, also referred to as b), a measure of a local variation of intensity is determined in the image data of the intact tissue biopsy in a region of at least one 2D image;

in a locating step 230, also referred to as step c), at least part of a tubulus is located in the region of the at least one 2D image on the basis of the determined measure of the local variation of intensity;

in the method, step c) comprises step c1), the determining 240 of locations in the region of the at least one 2D image where the measure of the local variation in intensity is below a threshold; and in an outputting step 250, also referred to as step d), data representative of the location of the at least part of the tubulus in the region of the at least one 2D image is output.

In an example, step b) comprises step b1, determining 222 at least one measure of sharpness in the image data of the intact tissue biopsy.

In an example, step b) comprises step b2, determining 224 at least one degree of focus in the image data of the intact tissue biopsy.

In an example, step b) comprises step b3, determining 226 at least one spatial frequency in the image data of the intact tissue biopsy.

In an example, step c) comprises analysing 232 a variation of the at least one spatial frequency. In an example, the analysing comprises utilising 234 a high-pass filter.

In an example, step b3) comprises applying 227 a 2D filter on each 2D image of the at least one 2D image.

In an example, the at least one 2D image comprises at least two 2D images, and step b3) comprises applying 228 a 3D filter on the at least one 2D image.

In an example, in step c1 the threshold is an adaptive threshold determined on the basis of at least one magnitude of the at least one spatial frequency.

In an example, step c) comprises step c2, determining 236 at least a part of an outer surface of the intact tissue biopsy in the image data of the intact tissue biopsy.

In an example, the at least one 2D images comprises at least two 2D images.

In an example, the intact tissue biopsy has not been stained.

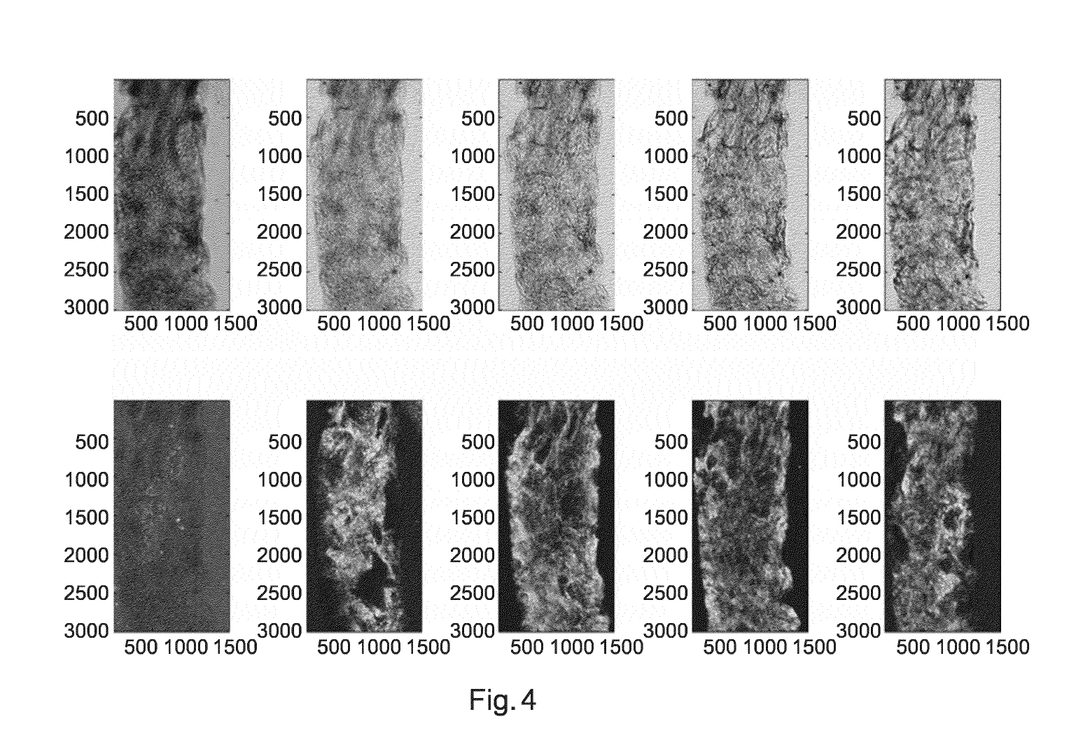

The apparatus, system and method for tubulus detection from a tissue biopsy are now described in further detail with reference to FIGS. 4-8.

A tissue biopsy is taken from the body. The biopsy is processed with a Clarity protocol to remove certain biomolecules (such as lipids) from the tissue, whilst retaining other biomolecules. However, the Clarity protocol does not have to be used, and “uncleared” tissue can be used. The tissue biopsy need not be stained, but can be stained if required. The tissue biopsy is cut to obtain a slice of a desired thickness to be analysed by a Bright Field Microscope, but does not need to be sliced into thin slices of the order of 4-10 μm as required in conventional 2D pathological imaging. In the present case, the sample can be of the order 50 μm to 5 mm in thickness, and in that sense is referred to as “intact” because it has not been sliced in the conventional sense of what such slicing means. The tissue biopsy is put in a (fluid) medium in a (potentially partially open) transparent container, and analysed with a Bright Field Microscope to obtain 3D image data comprising a z-stack of images. Such a microscope, for example, is the Philips oCelloScope system. The skilled person will however appreciate other ways by which the tissue biopsy can be interrogated.

The z-stacks of images output by the software of the oCelloscope are used, where to cover the entire depth of the 3D biopsy z-stacks corresponding to different focal depths are combined.

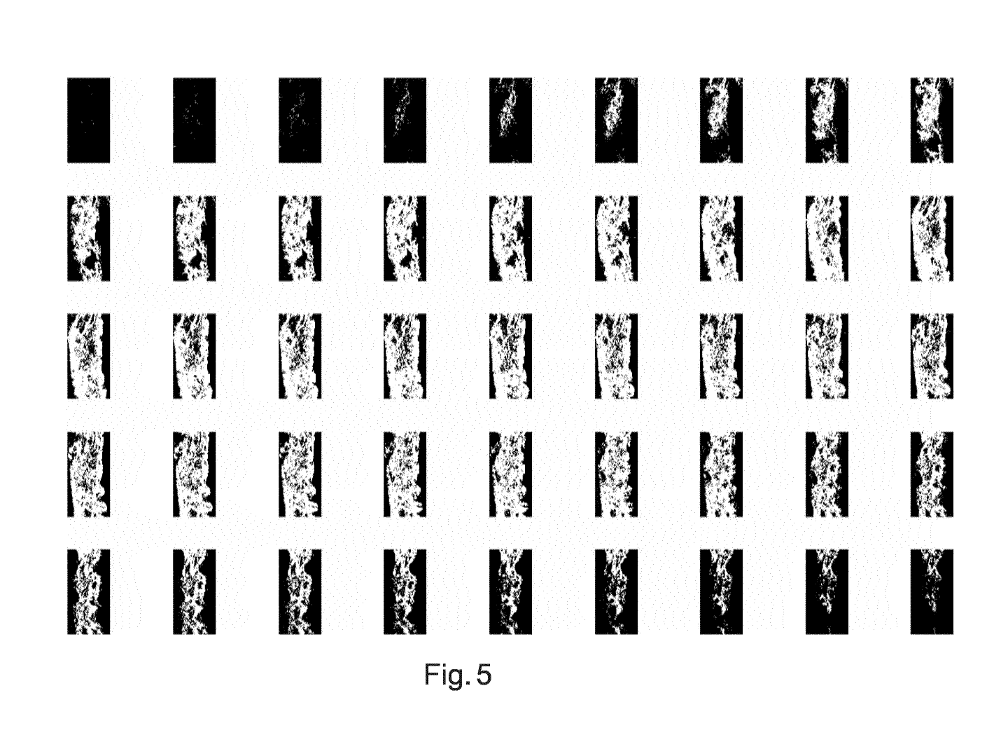

For cleared tissue—that has been processed with the Clarity protocol and where the sample is relatively transparent, with little light intensity variation over the tissue—the following detailed work plan can be utilised, which uses a fixed threshold
1. Each 2D image is filtered with a FIR high-pass filter (cut-off frequency fc) in both x and y dimension, resulting in a 2D output.
2. An absolute value is taken of the 2D filtered output. This is a metric expressing the high-spatial frequency magnitude.
   3. To smear out the local spatial variations in HF spatial frequencies, the resulting 2D data is filtered with a low-pass filter.
   (Note, FIG. 4 in the top row shows raw data images from different z-levels from the raw z-stack, and the bottom row shows corresponding images of the absolute value of the high-pass filtered output that has been subsequently low pass filtered. The intensity display is logarithmic, and black parts are out of focus and correspond to cavities (gas, fluids), whilst white parts are in focus and correspond to tissue. Cavities become visible (black regions) that are not immediately visible in the original images from the z-stack).
4. The resulting image is down-sampled in x and y direction to such a resolution that the voxel size in the x and y direction becomes similar to the voxel size in z direction (=distance between 2 images).
5. The resulting 2D image value is set to 1 if over a threshold, otherwise it is set to 0.
6. 2D images are combined into a 3D volumetric data description (for example, with 1=tissue, and 0=cavities).
   (Note, FIG. 5 shows the volume consisting of 45 slices in the z-direction. As can be seen, the biopsy comes into focus and moves out-of-focus when going in an increasing z-direction (top-left to bottom-right in image matrix).
      For uncleared tissue with light intensity variation over the tissue due to varying thickness and/or absorption and/or as a result of light scattering—the following detailed work plan can be utilised, which uses an adaptive threshold
1. Each 2D image is filtered with a FIR high-pass filter (cut-off frequency fc) in both x and y dimension, resulting in a 2D output.
2. The magnitude of spatial frequencies inside two spatial frequency bands is calculated:
   a. the magnitude of spatial frequencies in the frequency band 1 between fc and 2*fc is determined (this is a metric of a lower spatial frequency)
   b. the magnitude of spatial frequencies in the frequency band 2 between 2*fc and 3*fc is determined (this is a metric of a higher spatial frequency)
   c. Now the relative magnitude of spatial frequencies is calculated: divide the magnitude of spatial frequencies in band 1 by the magnitude of spatial frequencies in band 2.
3. To smear out the local spatial variations in the ratio of magnitudes of spatial frequencies, the resulting 2D magnitude data is filtered with a low-pass filter.
4. Similar to the calculation described above, this 2D data describing relative magnitudes of spatial frequencies is down-sampled,
5. The resulting 2D image value is set to 1 if the relative magnitude value is over a threshold, otherwise it is set to 0.
6. 2D images are combined into a 3D volumetric data description (for example, with 1=tissue, and 0=cavities).

It is to be noted, that the fixed threshold workplan as detailed above can also be applied to uncleared tissue, and the adaptive threshold workplan as detailed above can also be applied to cleared tissue.

The 3D volumetric data are processed as follows, to locate and segment the tubuli and ducts, with this process applying to both cleared and uncleared tissue samples
7. The single biopsy volume is isolated via 3D morphological operations.
8. The separate biopsy cavities are isolated via 3D morphological operations.
9. 3D volume filtering is applied.
10. Iso-surface rendering is carried out on the filtered 3D volume, for example using a threshold of 0.5.

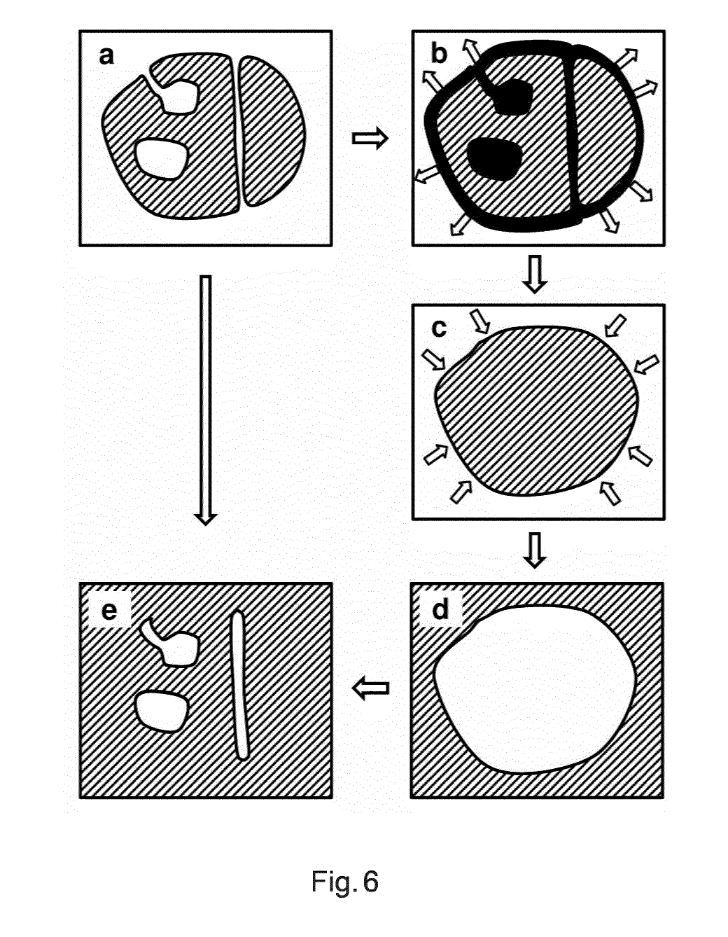

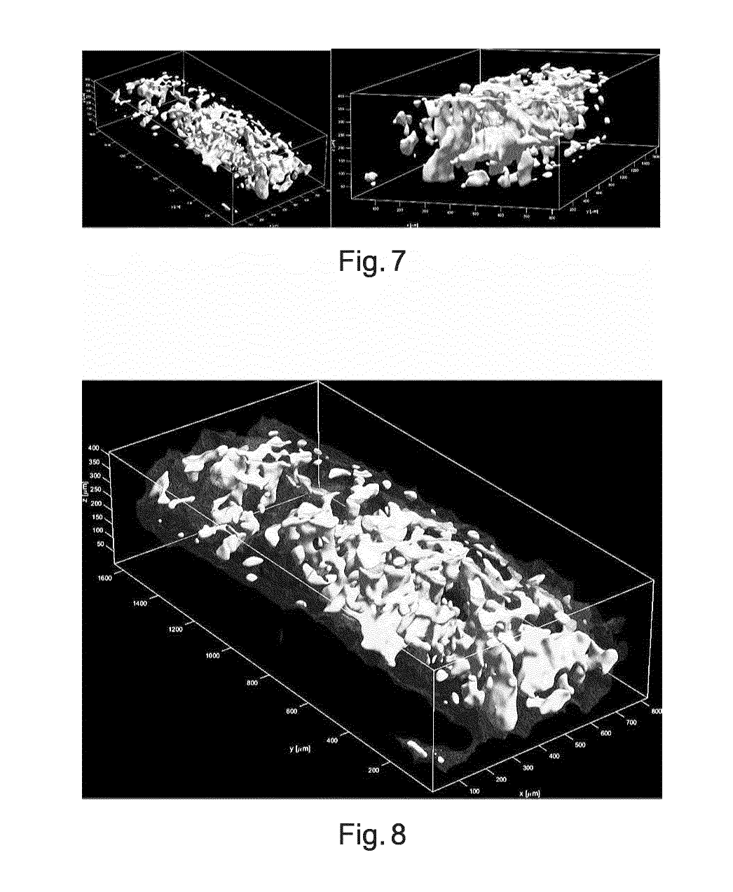

Regarding steps 7-8, in effect after creating the 3D binary volume a 3D volume rendering is created that displays the boundary between cavities and tissue. However, it can be difficult to easily associate this visualization with the binary images of FIG. 5, in which cross-sections of tubuli and ducts are seen. The problem lies in the fact that most cavities also touch the outer surface of the 3D biopsy which is therefore also rendered. To solve this a number of 3D image morphological operations are performed. First (at step 7) the single biopsy volume is isolated via morphological operations, with this being a dilation operation followed by an erosion operation (or equivalent operations based on the distance-transform). After that (at step 8) the separate cavities are isolated via Boolean NOT operations followed by Boolean OR operations. These image morphological operations are illustrated in FIG. 6. In more detail, and with reference to FIG. 6, the input volume (a) is first dilated such that cavities are filled. This dilated volume (b) is then eroded back (c). The outer surface of the 3D biopsy (ignoring cavities) can then be extracted. After applying the Boolean NOT operator (d) the cavities can be isolated by combining this volume with the original binary input volume using the Boolean OR operator (e). Separate surface renderings can now be produced for the cavities and for the surface that surrounds the 3D biopsy. 3D surface renderings of the cavities (tubuli or ducts) are shown in FIG. 7, and in FIG. 8 surface renderings of the cavities are shown along with the outer surface of the 3D biopsy, shown with 90% transparency.

Regarding steps 9 and 10, in order to get rid of smaller sized cavities (which can be present in large amounts), and only visualize larger sized cavities, the volumetric data (the combined downsampled binary images) is low-pass filtered in each of the x, y, z directions using a gaussian kernel. The standard deviation of the gauss curve (σ), can be varied as required and for example a window dimension of 6σ can be applied. As a result of the downsampling step done earlier, the value of sigma can be expressed in steps that are equal to the z-distance between 2 images. The resulting volumetric data is thresholded with a threshold value of 0.5 (with other threshold values being useable 0<1) and converted into a binary volumetric 3D data.

In this manner, the above described apparatus, system and method for tubulus detection from a tissue biopsy can be used:
In the detection of the ducts in a thick intact tissue biopsy (equal to, and greater than, a thickness of 500 μm and up to an order of magnitude thicker).
Cancer cells can be detected in thicker samples/biopsies, which would otherwise not be possible due to too high levels of emission.
Because tissue staining is not required to detect the cavities, ducts, tubuli, stainings for other purposes is enabled such as visualising other specific molecules that would not be possible if conventional staining was carried out in order to detect the cavities themselves.
Local properties of tubular structures (length, branching, density, tortuosity and orientation) can be determined, which could be an indication of angiogenesis. Thus, the apparatus, system and method can help to identify veins in tumeroids due to angiogenesis by cancer tissue (note that quite a few of the current cancer drugs work by suppressing angiogenesis, by which cancers tend to sustain themselves).

In another exemplary embodiment, a computer program or computer program element is provided that is characterized by being configured to execute the method steps of the method according to one of the preceding embodiments, on an appropriate system.

The computer program element might therefore be stored on a computer unit, which might also be part of an embodiment. This computing unit may be configured to perform or induce performing of the steps of the method described above. Moreover, it may be configured to operate the components of the above described apparatus. The computing unit can be configured to operate automatically and/or to execute the orders of a user. A computer program may be loaded into a working memory of a data processor. The data processor may thus be equipped to carry out the method according to one of the preceding embodiments.

This exemplary embodiment of the invention covers both, a computer program that right from the beginning uses the invention and computer program that by means of an update turns an existing program into a program that uses the invention.

Further on, the computer program element might be able to provide all necessary steps to fulfill the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

1. An apparatus for tubulus detection from a tissue biopsy, comprising:
an input unit;
a processing unit; and
an output unit;
wherein, the input unit is configured to provide the processing unit with a plurality of 2D images of a tissue biopsy that has a thickness d in the range 50 μm≤d≤5 mm, wherein the 2D images have been acquired by light microscopy such as by a bright field microscope or tomography microscope or transmission microscope, wherein each 2D image corresponds to a different depth position in the tissue biopsy, wherein each 2D image comprises image data of the tissue biopsy, and wherein the tissue biopsy has not been stained;
wherein, the processing unit is configured to determine a measure of a local variation of intensity in the image data of the tissue biopsy in a region of at least one 2D image, and wherein the determination of the measure of the local variation of intensity comprises a determination of spatial frequencies in the image data of the tissue biopsy;
wherein, the processing unit is configured to locate at least part of a tubulus in the region of the at least one 2D image on the basis of the determined measure of the local variation of intensity, comprising a determination of locations in the region of the at least one 2D image where the measure of the local variation in intensity is below a threshold; and
wherein, the output unit is configured to output data representative of the location of the at least part of the tubulus in the region of the at least one 2D image.

2. Apparatus according to claim 1, wherein the determination of the measure of the local variation of intensity comprises a determination of at least one degree of focus in the image data of the tissue biopsy.

3. (canceled)

4. Apparatus according to claim 3, wherein locating the at least part of the tubulus comprises an analysis of a variation of the spatial frequencies.

5. Apparatus according to claim 4, wherein the analysis comprises utilisation of a high-pass filter.

6. Apparatus according to claim 5, wherein the determination of the spatial frequencies in the image data of the tissue biopsy comprises application of at least one 2D filter on each 2D image of the at least one 2D image.

7. Apparatus according to claim 6, wherein the threshold is an adaptive threshold determined on the basis of at least one magnitude of the spatial frequencies.

8. Apparatus according to claim 7, wherein the at least one 2D image comprises at least two 2D images that are used to form a 3D image, and wherein the determination of the spatial frequencies in the image data of the tissue biopsy comprises application of a 3D filter on the 3D image formed from the at least one 2D image.

9. Apparatus according to claim 1, wherein locating the at least part of the tubulus comprises a determination of at least a part of an outer surface of the tissue biopsy in the image data of the tissue biopsy.

10. (canceled)

11. A system for tubulus detection from a tissue biopsy, comprising:
an image acquisition unit; and
an apparatus for tubulus detection from a tissue biopsy according to claim 1;
wherein, the image acquisition unit is configured to acquire the plurality of 2D images of the tissue biopsy.

12. A method for tubulus detection from a tissue biopsy, comprising:
a) providing a plurality of 2D images of a tissue biopsy that has a thickness d in the range 50 μm≤d≤5 mm, wherein the 2D images have been acquired by light microscopy such as by a bright field microscope or tomography microscope or transmission microscope, wherein each 2D image corresponds to a different depth position in the tissue biopsy, wherein each 2D image comprises image data of the tissue biopsy, and wherein the tissue biopsy has not been stained;
b) determining a measure of a local variation of intensity in the image data of the tissue biopsy in a region of at least one 2D image, and wherein the determination of the measure of the local variation of intensity comprises a determination of spatial frequencies in the image data of the tissue biopsy;
c) locating at least part of a tubulus in the region of the at least one 2D image on the basis of the determined measure of the local variation of intensity, comprising determining locations in the region of the at least one 2D image where the measure of the local variation in intensity is below a threshold; and
d) outputting data representative of the location of the at least part of the tubulus in the region of the at least one 2D image.

13. A computer program element, which when executed by a processor is configured to carry out the method of claim 12.

14. A computer readable medium having stored the program element of claim 13.

15. The method according to claim 12, wherein determining the spatial frequencies in the image data of the tissue biopsy comprises applying at least one 2D filter on each 2D image of the at least one 2D image.

16. The method according to claim 12, wherein the threshold is an adaptive threshold determined on the basis of at least one magnitude of the spatial frequencies.

17. The method according to claim 12, wherein the at least one 2D image comprises at least two 2D images that are used to form a 3D image, and wherein the determination of the spatial frequencies in the image data of the tissue biopsy comprises application of a 3D filter on the 3D image formed from the at least one 2D image.

18. The method according to claim 12, wherein locating the at least part of the tubulus comprises determining at least a part of an outer surface of the tissue biopsy in the image data of the tissue biopsy.

19. Apparatus according to claim 4, wherein the determination of the spatial frequencies in the image data of the tissue biopsy comprises application of at least one 2D filter on each 2D image of the at least one 2D image.

20. Apparatus according to claim 4, wherein the threshold is an adaptive threshold determined on the basis of at least one magnitude of the spatial frequencies.

21. Apparatus according to claim 4, wherein the at least one 2D image comprises at least two 2D images that are used to form a 3D image, and wherein the determination of the spatial frequencies in the image data of the tissue biopsy comprises application of a 3D filter on the 3D image formed from the at least one 2D image.
